(19) United States
(12) Patent Application Publication
(10) Pub. No.: US 2026/0122115 A1
(43) Pub. Date: Apr. 30, 2026

(54) COMPLIANCE ENGINE FOR MOBILE COMMUNICATION SESSIONS

(71) Applicant: AT&T Intellectual Property I, L.P., Atlanta, GA (US)

(72) Inventor: Joseph Soryal, Glendale, NY (US)

(21) Appl. No.: 18/927,821

(22) Filed: Oct. 25, 2024

(51) Int. Cl. H04L 65/1083; H04L 65/1069

(52) U.S. Cl. CPC H04L 65/1083; H04L 65/1069

(57) ABSTRACT

Method, computer-readable media, and apparatuses for detecting a trigger to activate a compliance engine for a communication session, activating the compliance engine to modify at least one communication feature of the mobile device in accordance with a compliance standard, detecting a completion of the communication session, deactivating the compliance engine and restoring the at least one communication feature of the mobile device to an original state are disclosed.

The present disclosure relates generally to security for communications, and relates more particularly to an apparatus, method, and non-transitory computer readable medium for a compliance engine that can be executed on a mobile device based on one or more triggers detected in a communication.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for activating a compliance engine on a mobile device to modify at least one communication feature for a communication session, in accordance with the present disclosure of the present disclosure;

FIG. 3 illustrates a more detailed flowchart of an example method for establishing a secure connection for a communication session, in accordance with the present disclosure; and

FIG. 4 depicts a high-level block diagram of a computing device or processing system specifically programmed to perform the functions described herein.

To facilitate understanding, similar reference numerals have been used, where possible, to designate elements that are common to the figures.

### DETAILED DESCRIPTION

In one example, the present disclosure describes a method, non-transitory computer-readable medium, and apparatus for activating a compliance engine on a mobile device to modify at least one communication feature for a communication session. For instance, in one example, a processing system including at least one processor may detect a trigger to activate a compliance engine for a communication session, may activate the compliance engine to modify at least one communication feature of the mobile device in accordance with a compliance standard, may detect a completion of the communication session, may deactivate the compliance engine and may restore the at least one communication feature of the mobile device to an original state.

Many enterprises may issue a separate mobile device or mobile telephone to their employees. The enterprise may issue dedicated mobile devices for work related use only due to various compliance reasons associated with a particular industry. For example, some compliance standards for financial companies may fine financial companies for executing client transactions on personal telephones of an employee. The medical field may have compliance standards for how a patient's case or medical records can be discussed over a personal telephone and/or issuing prescriptions using a personal telephone.

Thus, some employees may have to carry and use two or more different mobile devices. One mobile device for personal use and one mobile device that is dedicated for work in order to meet various compliance standards. This may become cumbersome for the employees. Employees would rather have to carry only one mobile device for work and personal use.

The present disclosure provides a compliance engine that can be added to a mobile device. When activated, the compliance engine may automatically activate some communication features, deactivate some communication features, or both activate and deactivate some communication features in accordance with a compliance standard. Thus, an employee can use a single mobile device. For example, the employee may be able to conduct work related telephone calls, or communication sessions, using a personal telephone, while satisfying associated compliance standards for an industry associated with the employee.

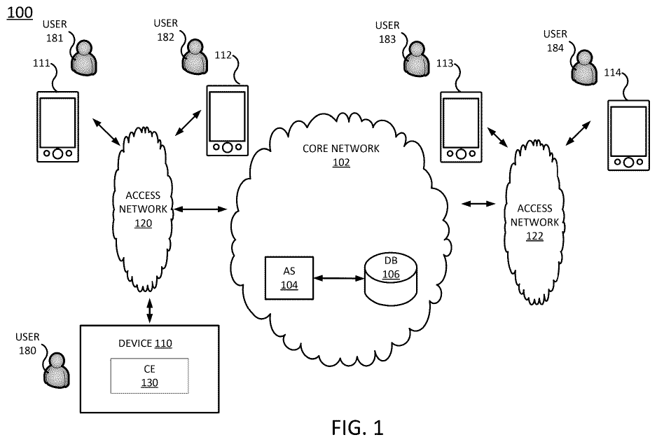

In an example, the compliance engine may be activated by an employee or may be automatically activated by the mobile device, e.g., as pre-configured for an enterprise. For example, an employee may manually activate the compliance engine if the employee knows he or she is about to conduct a business call. In another example, the compliance engine may be automatically activated based on contact information or keywords detected by the compliance engine. These and other aspects of the present disclosure are described in greater detail below in connection with the examples of FIGS. 1-4.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G and any future generation technology standard, e.g., 6G and the like), a long term evolution (LTE) network, and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a core network of a telecommunication network. The network 102 may be in communication with one or more access networks 120 and 122, and the Internet (not shown). In one example, network 102 may combine core network components of a cellular network with components of a triple play service network; where triple-play services include telephone services, Internet services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a broadcast television network, e.g., a traditional cable provider network or an Internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video-on-demand (VoD) server, and so forth. For ease of illustration, various additional elements of network 102 are omitted from FIG. 1.

In one example, the network 102 may also include various servers and/or processing systems that perform various functions for the core network. For example, the network 102 may include an access and mobility management function (AMF), a session management function (SMF), a policy control function (PCF), and unified data management (UDM). The AMF, SMF, PCF, and UDM may operate to help establish a secure connection and work with a compliance engine (CE) 130 on a device 110, as discussed in further details below.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like. In one example, each of access networks 120 and 122 may include at least one access point, such as a cellular base station, non-cellular wireless access point, a digital subscriber line access multiplexer (DSLAM), a cross-connect box, a serving area interface (SAI), a video-ready access device (VRAD), or the like, for communication with various endpoint devices.

In one example, the access networks 120 and 122 may also include a radio access network (RAN) and a user plane function (UPF). The RAN and the UPF may operate to help establish a secure connection and operate with the CE 130 on the device 110, as discussed in further details below.

In one example, the access networks 120 may be in communication with one or more devices 110-112. Similarly, access networks 122 may be in communication with one or more devices, e.g., devices 113 and 114, and so forth.

Access networks 120 and 122 may transmit and receive communications between devices 110-114, application server (AS) 104 and/or database (DB) 106, other components of network 102, devices reachable via the Internet in general, and so forth.

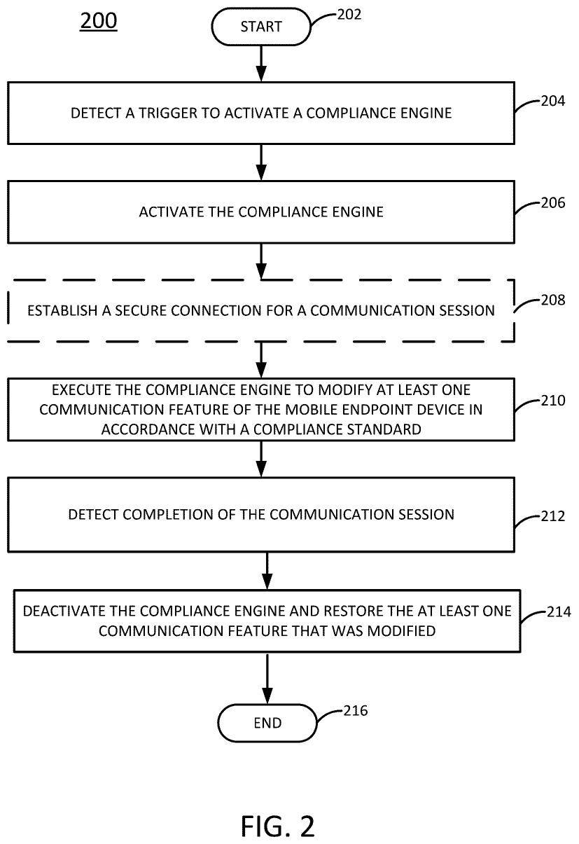

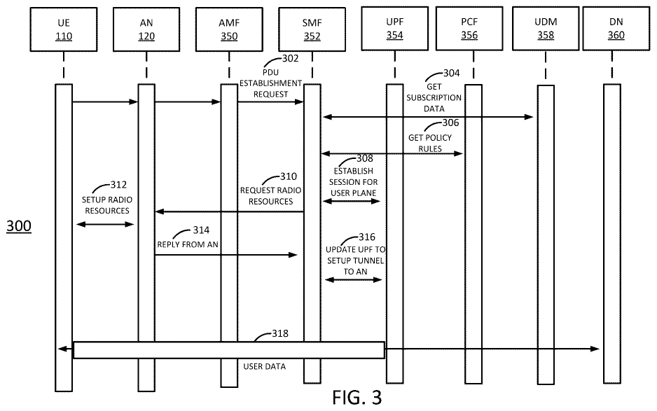

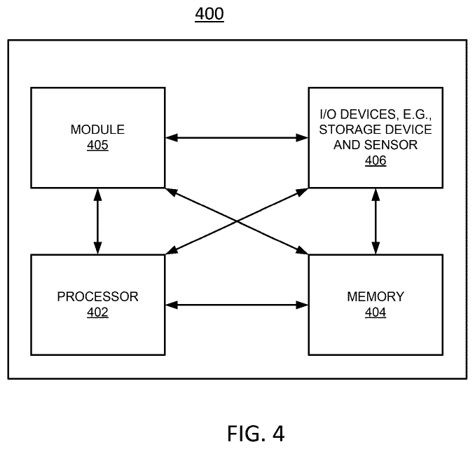

In one example, each of the devices 110-114 may comprise any single device or combination of devices that may comprise a user endpoint device or a mobile device. For example, the devices 110-114 may each comprise a mobile computing device, e.g., a cellular smart phone, a laptop, a tablet computer, a wearable computing device (e.g., a smart watch, a smart pair of eyeglasses, etc.), a desktop computer, an application server, a bank or cluster of such devices, and the like. In accordance with the present disclosure, each of the devices 110-114 may comprise a computing system or server, such as computing system 400 depicted in FIG. 4, and may be configured to perform operations or functions in connection with examples of the present disclosure for activating a compliance engine on a mobile device to modify a communication session (such as illustrated and described in connection with the example methods 200 or 300 of FIGS. 2 and 3, respectively).

In one example, the device 110 may include the CE 130. However, it should be noted that the CE 130 may also be installed on any other devices 111-114. The CE 130 may be a shell compliance engine that is executed by the device 110 to perform the functions described herein.

In one example, the CE 130 may be a virtual machine that is isolated from other applications and processes executed by the device 110. For example, the CE 130 may be allocated a dedicated portion of the memory and processing resources from a processor of the device 110 that is dedicated to the operation and execution of the CE 130. In other words, the memory and processing resources dedicated to the CE 130 are not shared with other applications being executed on the device 110.

As discussed in further details below, when triggered, the CE 130 may be activated on the device 110 to ensure that communication sessions between the device 110 and any other devices 111-114 are compliant with a compliance standard. This may allow a user's personal device to also be used as a work device without violating compliance standards associated with a particular industry.

In an example, when a trigger is detected, a secure connection may be established for the communication session before the CE 130 is activated. For example, the secure connection may be a secure tunnel that can be established across the entire connection between devices 110-114 or may be multiple segments of secure tunnels. For example, the secure tunnel may be established between the device 110 and the access network 120 and the access network 120 to the network 102 and beyond, if necessary, e.g., a website hosted on an application server deployed external to the core network 102. FIG. 3 describes a flow diagram of an example method for establishing the secure tunnel.

In one example, the access networks 122 may also be in communication with the AS 104 and DB 106. In accordance with the present disclosure, the AS 104 may comprise a computing system or server, such as computing system 400 depicted in FIG. 4, and may individually or collectively be configured to perform operations or functions to assist in performing compliance functions as requested by the CE 130. For instance, the AS 104 may store voice recordings, deactivate storage servers to prevent recording of voice calls, data, and the like, automatically establish voice connections to third parties, etc.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, DB 106 may comprise one or more physical storage devices integrated with AS 104 (e.g., a database server), attached or coupled to the AS 104, or remotely accessible to the AS 104 to store various types of information in support of systems for ensuring that a communication session is compliant with a compliance standard, in accordance with the present disclosure. For example, DB 106 may include a user profile database that may store a record (e.g., a user profile) for each user that has downloaded the application associated with the CE 130 on to his or her device. The DB 106 may store different compliance standards and which users are required to comply with which compliance standards. For example, some users may work in multiple industries and the user may be required to comply with different compliance standards associated with different industries. The DB 106 may store keyword or topics that may be associated with a compliance standard. The DB 106 may store locations that may be associated with a compliance standard. The DB 106 may store which communication features should be activated or deactivated based on each one of the different compliance standards.

For example, the DB 106 may store one or more topic or keyword detection models (e.g., machine learning models (MLMs)) for detecting topics or keywords in the content of a communication session. Detection of a topic or keyword associated with a compliance standard may be used to automatically trigger activation of the CE 130, as discussed in further details below.

In one example, the topic or keyword detection model(s) may comprise one or more machine learning algorithms (MLAs) and/or trained MLAs, e.g., MLMs. It should be noted that as referred to herein, a machine learning model (MLM) (or machine learning-based model) may comprise a machine learning algorithm (MLA) that has been “trained” or configured in accordance with input training data to perform a particular service (e.g., prediction, detection, classification, etc.). For instance, an MLM may comprise a deep learning neural network, or deep neural network (DNN), a convolutional neural network (CNN), a generative adversarial network (GAN), a decision tree algorithm/model, such as gradient boosted decision tree (GBDT) (e.g., XGBoost, XGBR, or the like), a support vector machine (SVM), e.g., a non-binary, or multi-class classifier, a linear or non-linear classifier, k-means clustering and/or k-nearest neighbor (KNN) predictive models, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented as topic detection models in examples of the present disclosure.

In one example, a topic may comprise a “concept” from a lexical database. For example, the Large Scale Theme Ontology for Multimedia (LSCOM) has hundreds of “themes,” such as: “parade,” “exiting car,” “handshaking,” “running,” “rocket launching,” “barn,” “college,” “castle,” “conference room,” “emergency room,” “bathroom,” “interview on location,” “text on artificial background,” “ship,” “shipyard,” “birds,” “face,” “bicycle,” and so on. Other examples include LSCOM-Lite, which has 39 themes, National Institute of Standards and Technology (NIST) Text REtrieval Conference (TREC) Video Retrieval Evaluation (TRECVID) 2016 lexical themes, and the like. In one example, the present disclosure may utilize a lexicon that is specific to a subject area or field to determine various topics present in the content of a communication session. For instance, a first lexicon may be used for topics related to the medical industry, a second lexicon may be used for topics related to the financial industry, and so forth. Thus, the present disclosure may function with any lexicon that is presently available or that is later developed.

Notably, classifiers can be trained from any text, video, image, audio and/or other types of content to recognize various topics. Topic identification classifiers may include support vector machine (SVM) based or non-SVM based classifiers, such as neural network based classifiers. The classifiers may be trained upon and utilize various data points to recognize topics in scenes or texts. For instance, classifiers may use low-level invariant image data, such as colors, shapes, color moments, color histograms, edge distribution histograms, etc., may utilize speech recognition pre-processing to obtain an audio transcript and to rely upon various keywords or phrases as data points, may utilize text recognition pre-processing to identify keywords or phrases in captioned text as data points, may utilize image salience to determine whether detected objects are “primary” objects of a scene or are less important or background objects, and so forth. The inputs to the classifiers may vary depending on the nature of the posts. In one example, different classifiers may be trained and may be deployed that may detect the same theme, but within different types of inputs. In one example, a classifier may have multi-modal inputs, e.g., image data plus text caption data may comprise predictors to a single multi-modal classifier.

In an illustrative example, the user 180 may have a device 110 that is a personal device. The device 110 may be a mobile device. The user 180 may also work for a financial company that has certain rules under a compliance standard for communications with a client. The user 180 may download and install the application including the CE 130 on the device 110. In an example, the user 180 may also register the device 110 with the AS 104 as a subscriber to the services associated with the CE 130.

The compliance standard for the financial industry may be stored in the DB 106. The compliance standard may include certain keywords and/or topics that will trigger an activation of the CE 130 during a communication session. The compliance standard may also indicate what communication features should be activated and/or deactivated when the CE 130 is activated on the device 110.

For example, the compliance standard for the financial industry may require that voice communications with a client are to be recorded and stored for record keeping. In addition, any data transmissions (e.g., a financial transaction) may be required to be encrypted.

A user 182 may be a client and uses the device 112 to call device 110 of the user 180. In an example, the user 180 may recognize the incoming telephone number (e.g., a caller ID) and activate the CE 130 manually. For example, the user 180 may select an option to activate the CE 130 on the user interface of the device 110. Thus, the CE 130 may be triggered manually to be activated.

In another example, a trigger to activate the CE 130 may be detected automatically. For example, the CE 130 may recognize the incoming telephone number or an IP address of the device 112 as a client. In another example, telephone numbers of all clients for an enterprise can be stored in the DB 106. The AS 104 may compare the incoming telephone number to the client telephone numbers stored in the DB 106 before connecting the telephone call to device 110. The AS 104 may determine that the incoming telephone number is a client number and send a control signal to the device 110 to activate the CE 130 with the incoming call.

Although the incoming telephone number or IP address are used as examples of contact information that can be used to detect a trigger, it should be noted that other types of contact information can also be used. For example, other types of contact information may include an outgoing telephone number, an email address, and the like.

Once the CE 130 is activated, the CE 130 may activate the communication features of recording the voice call and encrypting any data transmitted from the device 110. The user 180 may execute a financial transaction on the device 110 and the transaction can be encrypted before being sent to a financial institution.

In an example, the CE 130 may also continuously monitor the communication session. For example, the CE 130 may analyze the conversation to detect keywords or topics, as described above. In an example, the CE 130 may provide a notification whenever a keyword or topic is detected. For example, the compliance standard may define certain keywords or topics that should not be discussed during a call. When the keyword or topic is detected, the CE 130 may provide an audible notification (e.g., a beep, an automated voice message, a tone, and the like), provide a visual notification (e.g., a pop-up message on the screen, a flash on the screen, and the like), or a haptic notification (e.g., buzzing the mobile device 110). This may make the user 180 aware when certain keywords or topics are detected that the user 180 should avoid discussing in accordance with the pertinent compliance standard.

After the call is completed, the voice recording may be transmitted to a storage server for storage per the compliance standard. After the call is completed (e.g., one or both parties may end the call), the CE 130 may be deactivated and any memory and/or processing resources dedicated to the CE 130 may be released for use by other applications on the device 110.

In one example, the trigger to activate the CE 130 may be detected during a call, e.g., after the communication session has been established. For example, the user 182 may be a friend of the user 180. The user 182 may call the user 180 via the devices 112 and 110. Initially, the user 182 and the user 180 may converse about personal affairs. However, during the conversation, the user 182 may transition to asking about making a financial transaction. The device 110 or the AS 104 may use transcribing programs, topic detection models, or keyword detection models (described above) to detect a topic or keyword. For example, the device 110 or the AS 104 may detect the keyword “trade,” “money,” “banking,” etc. In response, the device 110 or the AS 104 may cause the CE 130 to be activated in response to the detected trigger. The CE 130 may then activate and/or deactivate certain communication features in accordance to the compliance standard.

In another example, the CE 130 may dynamically activate and/or deactivate various communication features while the communication session is occurring. For example, the user 180 may be a doctor who is currently driving. A user 181 may be patient that is calling the user 180 for a prescription via device 111. The compliance standard for the medical industry may be stored in the DB 106. In an example, the compliance standard for the medical industry may be that conversations with patients are not to be recorded or stored. In addition, prescriptions can only be written in a state where the doctor practices.

The user 181 may use the device 111 to call device 110 of the user 180. The CE 130 may be activated in response to a detected trigger, as described above. For example, the incoming telephone number may be detected as a patient telephone number or a keyword or topic may be detected during the telephone call after the communication session was established. After the CE 130 is activated, the CE 130 may deactivate the communication feature of voice recording or storing any data associated with the communication session with the user 181.

The user 180 may be driving in a state where the user 180 practices when the communication session begins. However, the user 180 may cross the boundary into another state while driving and speaking to the user 181. As a result, the CE 130 may monitor a location of the device 110, e.g., using a global positioning system (GPS) functionality of the device 110. When the CE 130 detects that the device 110 has crossed into another state where the user 180 does not practice (e.g., not licensed to practice), the CE 130 may disable a prescription writing application on the device 110. As a result, the user 180 may be unable to write a prescription or transmit a prescription electronically for the user 181 until the device 110 returns to the state where the user 180 practices (e.g., licensed to practice).

In another example, the trigger may be based on a location. For example, a compliance standard for a company (e.g., a military contractor for the military services) may require no pictures, video, or communications to be transmitted in certain buildings that may have trade or governmental secrets. The user 180 may work for the company and enter a building where no pictures, video, or communications are permitted. The device 110 or the AS 104 may detect the location of the device 110 as being within the building and activate the CE 130 in response to detecting the trigger.

After the CE 130 is activated, the CE 130 may deactivate the multimedia capture and communication features of device 110 (e.g., disabling a camera, a microphone, and a transceiver on the device 110). The CE 130 may also disable certain applications on the device 110, such as, a texting application, an email application, a voice call application, (e.g., turning on an “airplane” mode on the device 110) and the like. In an example, the CE 130 may disable any wireless communication interfaces (e.g., the cellular radio, the WiFi interface, the Bluetooth interface, and the like) until the device 110 leaves the building. When the device 110 is determined to be external or outside of the building (e.g., external to the building and at least 100 feet away), the CE 130 may be deactivated and all of the communication features of the device 110 may be restored.

In another example, the user 180 may work as a customer service representative for a company. The user 180 may be a trainee. A compliance standard for the company or for the customer service industry may require that any customer service calls are logged, recorded, and that a supervisor be connected to the call while the user 180 is still in training.

A user 183 may call for customer service using the device 113. The call may be routed to the device 110 of the user 180. The CE 130 may be triggered to activate, as described above. After the CE 130 is activated, the CE 130 may transmit a notification to a supervisor (e.g., a user 184) that a customer service call has been routed to the device 110 of the user 180. The CE 130 may then automatically send a control signal to the AS 104, or the device 114 directly, to connect the device 114 to the call between the device 110 and the device 113. The CE 130 may activate the communication feature of recording the call after the device 114 is connected to the call.

After the call ends, the CE 130 may be deactivated. The memory and processing resources dedicated to the CE 130 may be released and used by other applications again on the device 110.

It should be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102 and/or access networks 120 and 122 may comprise a content distribution network (CDN) having ingest servers, edge servers, and the like, for packet-based streaming of videos or video segments that may be provided in accordance with the present disclosure. Similarly, although only two access networks 120 and 122 are shown, in other examples, access networks 120 and/or 122 may each comprise a plurality of different access networks that may interface with network 102 independently or in a chained manner. For example, device 113 or device 114, may be in communication with network 102 via different access networks, and so forth. Thus, these and other modifications are all contemplated within the scope of the present disclosure.

FIG. 2 illustrates a flowchart of an example method 200 for activating a compliance engine on a mobile device to modify at least one communication feature for a communication session, in accordance with the present disclosure. In one example, steps, functions and/or operations of the method 200 may be performed by a device as illustrated in FIG. 1, e.g., mobile devices 110, or any other mobile devices 111-114 having the CE 130 downloaded and installed onto the device. In one example, the steps, functions, or operations of method 200 may be performed by a computing device or system 400, and/or a processing system 402 as described in connection with FIG. 4 below. For instance, the computing device 400 may represent at least a portion of the mobile devices 110, 111, 112, 113, or 114 or any other hardware devices in accordance with the present disclosure. For illustrative purposes, the method 200 is described in greater detail below in connection with an example performed by a processing system, such as processing system 402.

The method 200 begins in step 202 and proceeds to step 204. In step 204, the processing system may detect a trigger to activate a compliance engine. For example, the trigger may be detected automatically or via a manual selection by a user. For the manual selection, the user may open the compliance engine application on the mobile device manually or choose an “activate” option in the compliance engine application.

In other examples, the trigger may be detected automatically. As described above, the trigger may be detected at the beginning of a communication session or in the middle of a communication session. A communication session may be a voice call, video call, a text message, a data transmission (e.g., an email exchange, transmission of photos or video, a social media post), and the like.

When detected at the beginning of the call, the trigger may be detected based on an incoming telephone number (e.g., from a caller ID). The incoming telephone number may be associated with a client for a business that complies with a particular compliance standard. The trigger may be detected based on a location of the mobile device. For example, the mobile device may be in a secure location where pictures and/or transmission of data are prohibited.

In an example, keyword or topic detection models may be used to detect the trigger during the middle of the communication session. For example, a keyword may be detected during a conversation on a call or in the text of a text message. In another example, the trigger may be detected based on location if the mobile device is moving (e.g., using current GPS coordinates of the mobile device). For example, a user may be driving across state lines causing the location to change. The trigger may be detected in the middle of the communication session based on the change in location of the mobile device.

At step 206, the processing system may activate the compliance engine. For example, the compliance engine may be a shell compliance engine that is deployed as a virtual machine. The virtual machine may isolate portions of the memory and processing resources of the processor to dedicate those portions to the compliance engine. Thus, other applications running on the mobile device may not have access to the dedicated portions of memory and processing resources assigned to the compliance engine. Once the compliance engine is terminated, the dedicated portions of the memory may be released and be available to the other applications again.

At optional step 208, the processing system may establish a secure connection for a communication session. In an example, a secure tunnel may be established between the mobile device and the network and/or another mobile device communicating with the mobile device with the compliance engine. This secure connection is only triggered if the pertinent compliance standard requires such a secure connection to be established to meet compliance. It should be noted that optional step 208 can be implemented before step 206 instead. FIG. 3 illustrates an example method of how the secure connection can be established.

At step 210, the processing system may execute the compliance engine to modify at least one communication feature of the mobile device in accordance with a compliance standard. For example, the modification may include activating at least one communication feature, deactivating at least one communication feature, or a combination of activating and deactivating at least one communication feature.

In an example, the communication feature may be modified at the beginning of the communication session or the compliance engine may continuously monitor the communication session to dynamically modify one or more communication features while monitoring the interactions between the parties. For example, keywords or topics can be detected during the communication session to modify a communication feature or the location of the device may change during the communication session causing the compliance engine to dynamically modify a communication feature.

In an example, activating at least one communication feature may include encrypting the communication session, logging the communication session, transmitting a notification to at least one third party, recording the communication session, and/or automatically connecting a third party to the communication session. Logging the communication session may include recording the parties associated with the communication session, the content of the communication session, and a location of the mobile device during the communication session. The content may include text of the communication session transcribed by a voice transcribing/analysis module and/or an artificial intelligence (AI) module. In an example, deactivating at least one communication feature may include disabling a video camera of the mobile device, disabling a wireless communication interface, disabling an application on the mobile device, and/or transmitting a control signal to a network storage server to prevent recording of the communication session.

In an example, there may be different compliance standards associated with different industries. Each compliance standard may have a different set of communication features that should be activated and/or deactivated. For example, a compliance standard for the financial industry may activate encryption of data transmission, recording the voice call, and storage of the voice call. A compliance standard for the medical industry may deactivate recording of the voice call feature and deactivate a prescription writing application based on a location of the mobile device. A compliance standard for a secure location may deactivate a video camera on the mobile device, deactivate text and email transmission, and deactivate any voice recordings for communication sessions. The above are provided as examples only and it should be noted that other industries with different compliance standards may be deployed.

In an example, different compliance standards may be loaded onto the compliance engine or stored in the network. In another example, the user may select which compliance standards should be added to the compliance engine based on the industry or industries associated with the employer of the user. For example, the user may be a part time real estate agent while working full time in the financial industry. In this example, the user may have to choose the pertinent compliance standards between the real estate industry and the financial industry.

At step 212, the processing system may detect completion of the communication session. For example, the communication session may end or the user may manually provide a signal to turn off the compliance engine.

At step 214, the processing system may deactivate the compliance engine and restore the at least one communication feature that was modified in step 210. When the compliance engine is terminated, the memory and processing resources that were dedicated to the compliance engine may be returned to the pool of memory and processing resources to be available for other applications on the mobile device. Furthermore, any communication features that were modified in step 210 will be returned to their original states, e.g., reactivating features that were turn off and deactivating features that were turned on. In addition, the secure connection may be torn down between the mobile device and the network and/or the calling mobile device if optional step 208 was implemented. The method 200 may end in step 216.

FIG. 3 illustrates a more detailed flowchart of an example method 300 for establishing a secure connection for a communication session, in accordance with the present disclosure. The method 300 may be performed between various network devices in the network 100. For example, the method 300 may be performed by devices including the user endpoint (UE) 110, the access network (AN) 120, the AMF 350, the SMF 352, the UPF 354, the PCF 356, the UDM 358, and a data network (DN) 360. In an example, the DN 360 may be the AS 104 and the DB 106 in the network 102, illustrated in FIG. 1, and described above.

At step 302, a packet data unit (PDU) from the UE 110 may send a session establishment request to the SMF 352. At step 304, the SMF 352 may get subscription data from the UDM 358. At step 306, the SMF 352 may get one or more policy rules from the PCF 356. At step 308, the SMF 352 may establish a session for the user plane with the UPF 354. At step 310, the SMF 352 may request radio resources from the AN 120. At step 312, the AN 120 may setup radio resources between the UE 110 and the AN 120. At step 314, the SMF 352 may receive a reply from the AN 314. At step 316, the SMF 352 may update the UPF 354 to setup a secure tunnel to the AN 120. At step 318, the secure tunnel may be established between the UE 110 and the UPF 354 and user data may be securely transmitted over the secure tunnel. It should be noted that this is simply an example method of establishing a secure tunnel. Different embodiments may require the secure tunnel to be extended to other entities.

It should be noted that the methods 200 and 300 may be expanded to include additional steps or may be modified to include additional operations with respect to the steps outlined above. In addition, although not specifically specified, one or more steps, functions, or operations of the methods 200 and 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIGS. 2 and 3 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing system 400 (e.g., a computing device or processing system) specifically programmed to perform the functions described herein. For example, any one or more components, devices, and/or systems illustrated in FIG. 1, or described in connection with FIG. 2 or FIG. 3, may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where the hardware processor element 402 may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for activating a compliance engine on a mobile device to modify at least one communication feature for a communication session, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, the computing system 400 may employ a plurality of hardware processor elements. Furthermore, although only one computing device is shown in FIG. 4, if the method(s) as discussed above is implemented in a distributed or parallel manner for a particular illustrative example, e.g., the steps of the above method(s) or the entire method(s) are implemented across multiple or parallel computing devices, then the computing system 400 of FIG. 4 may represent each of those multiple or parallel computing devices. Furthermore, one or more hardware processor elements (e.g., hardware processor element 402) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 405 for activating a compliance engine on a mobile device to modify at least one communication feature for a communication session (e.g., a software program comprising computer-executable instructions) can be loaded into memory 404 and executed by hardware processor element 402 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 402) executing the computer-readable instructions relating to the above described method(s) can be perceived as a programmed processor or a specialized processor. As such, the present module 405 for activating a compliance engine on a mobile device to modify at least one communication feature for a communication session (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
detecting, by a processing system including at least one processor of a mobile device, a trigger to activate a compliance engine for a communication session;
activating, by the processing system, the compliance engine to modify at least one communication feature of the mobile device in accordance with a compliance standard;
detecting, by the processing system, a completion of the communication session;
deactivating, by the processing system, the compliance engine; and
restoring, by the processing system, the at least one communication feature of the mobile device to an original state.

2. The method of claim 1, further comprising:
establishing in response to the detecting, by the processing system, a secure connection for the communication session.

3. The method of claim 1, wherein the communication session comprises at least one of: a voice call session, a data transmission session, a video call session, or a text messaging session.

4. The method of claim 1, wherein the trigger comprises a user selection to activate the compliance engine.

5. The method of claim 1, wherein the detecting the trigger comprises:
detecting, by the processing system, that the mobile device is in a location that is associated with the compliance standard.

6. The method of claim 1, wherein the detecting the trigger comprises:
detecting, by the processing system, a keyword associated with the compliance standard via a voice analysis module.

7. The method of claim 1, wherein the detecting the trigger comprises:
detecting, by the processing system, contact information associated with a party of the communication session is associated with the compliance standard.

8. The method of claim 7, wherein the contact information comprises at least one of: an outgoing telephone number, an incoming telephone number, an email address, or an internet protocol address.

9. The method of claim 2, wherein the secure connection comprises a tunnel between the mobile device and a data network associated with the communication session.

10. The method of claim 1, wherein the activating the compliance engine to modify the at least one communication feature of the mobile device comprises at least one of:
activating, by the processing system, the at least one communication feature in accordance with the compliance standard; or
deactivating, by the processing system, the at least one communication feature in accordance with the compliance standard.

11. The method of claim 10, wherein the activating the at least one communication feature comprises at least one of: encrypting content of the communication session, logging of the communication session, transmitting a notification to at least one third party, recording content of the communication session, or automatically connecting a third party to the communication session.

12. The method of claim 11, wherein the logging of the communication session comprises recording interactions of parties associated with the communication session, content of the communication session, and a location of the mobile device during the communication session.

13. The method of claim 12, wherein the content of the communication session comprises at least one of: text of the communication session transcribed by a voice transcribing module or data exchanged during the communication session.

14. The method of claim 10, wherein the deactivating the at least one communication feature comprises at least one of: disabling a video camera of the mobile device, disabling a wireless communication interface of the mobile device, disabling an application on the mobile device, or transmitting a control signal to a network storage server to prevent a recording of the communication session.

15. The method of claim 10, wherein the compliance standard comprises a plurality of different compliance standards and each one of the plurality of different compliance standards defines a different set of communication features to be activated or deactivated.

16. The method of claim 1, wherein the activating the compliance engine, comprises:
assigning, by the processing system, a portion of a memory and a portion of a processing resource of the processing system for the compliance engine; and
executing, by the processing system, the compliance engine with the portion of the memory and the portion of the processing resource of the processing system assigned to the compliance engine.

17. The method of claim 1, wherein the compliance standard is associated with a particular industry.

18. The method of claim 1, wherein the detecting the trigger is performed after the communication session has been established.

19. A non-transitory computer-readable medium storing instructions which, when executed by a processing system of a mobile device including at least one processor, cause the processing system to perform operations, the operations comprising:
detecting a trigger to activate a compliance engine for a communication session;
activating the compliance engine to modify at least one communication feature of the mobile device in accordance with a compliance standard;
detecting a completion of the communication session;
deactivating the compliance engine; and
restoring the at least one communication feature of the mobile device to an original state.

20. An apparatus comprising:
a processing system of a mobile device including at least one processor; and
a computer-readable medium storing instructions which, when executed by the processing system, cause the processing system to perform operations, the operations comprising:
detecting a trigger to activate a compliance engine for a communication session;
activating the compliance engine to modify at least one communication feature of the mobile device in accordance with a compliance standard;
detecting a completion of the communication session;
deactivating the compliance engine; and
restoring the at least one communication feature of the mobile device to an original state.
